(19) United States
(12) Patent Application Publication
(10) Pub. No.: US 2008/0094576 A1
(43) Pub. Date: Apr. 24, 2008

(54) PROJECTION SYSTEM INCORPORATING COLOR CORRECTING ELEMENT

(75) Inventor: Charles L. Bruzzone, Woodbury, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/538,655

(22) Filed: Oct. 4, 2006

(51) Int. Cl. G03B 21/14

(52) U.S. Cl. 353/20; 359/487

(57) ABSTRACT

An optical system and a projection system incorporating same are disclosed. The optical system includes first and second optical elements. The second optical element is polarization insensitive in the visible. The first optical element is capable of receiving light of a first polarization along a first direction and transmitting the received light along the first direction. The first optical element is also capable of receiving light of a second polarization orthogonal to the first polarization along the first direction and reflecting the received light along a second direction different from the first direction. When the optical system receives light of the first polarization along the second direction, the first optical element transmits the received light along the second direction. The transmitted light has the first polarization and a first set of color coordinates. The second optical element transmits at least a portion of the light transmitted by the first optical element. The light transmitted by the second optical element has a second set of color coordinates that is different from the first set of color coordinates.

### FIELD OF THE INVENTION

This invention generally relates to projection systems. The invention is particularly applicable to projection systems having one or more telecentric spaces.

### BACKGROUND

Projection systems utilize one or more image forming devices that are capable of forming an image that is projected onto a screen for display to a viewing audience. Examples of image forming devices include reflective or transmissive liquid crystal display (LCD) panels. In the case of a reflective LCD panel, projection systems often use a polarizing beam splitter (PBS) to separate the illumination light that is incident onto the LCD from image light that is reflected by the LCD and which carries an image for projection onto the projection screen. In such systems, the illumination light is passed through the PBS before reaching the LCD and, therefore, the incident illumination light is typically polarized prior to reaching the LCD.

The LCD panel includes many pixels, where each pixel can be controlled electronically to modulate the polarization of light that is incident onto the pixel. In general, an LCD pixel corresponding to a dark area of a projected image does not alter the polarization state of the light incident onto the pixel whereas a pixel corresponding to a bright area of the projected image does alter the polarization state of the incident light.

Many projection systems use a single light source and three LCD panels, one for each primary color. In such systems, color separating elements are used to separate white light that is generated by the light source into the three primary colors.

### SUMMARY OF THE INVENTION

Generally, the present invention relates to projection systems. The present invention also relates to projection systems employing color correcting components.

In one embodiment of the invention, an optical system includes first and second optical elements. The second optical element is polarization insensitive in the visible. The first optical element is capable of receiving light of a first polarization along a first direction and transmitting the same along the first direction. The first optical element is also capable of receiving light of a second polarization orthogonal to the first polarization along the first direction and reflecting the same along a second direction different from the first direction. When the optical system receives light of the first polarization along the second direction, the first optical element transmits the received light along the second direction. The light transmitted by the first optical element has the first polarization and a first set of color coordinates. The second optical element transmits at least a portion of the light transmitted by the first optical element. The light transmitted by the second optical element has a second set of color coordinates different from the first set of color coordinates.

In another embodiment of the invention, a polarizing beam splitter includes a first optical component that has a first face, a second optical component that has a first face, and a polarizing element that is disposed between the first faces of the first and second optical components. The polarizing element is capable of transmitting light of a first polarization and reflecting light of a second polarization where the second polarization is orthogonal to the first polarization. The polarizing beam splitter further includes a color filter that is disposed on a face of one of the first and second optical components. The color filter is polarization insensitive in the visible and is capable of changing a color coordinate of light incident on the color filter.

In another embodiment of the invention, a projection system includes an imager capable of forming an image, a projection lens system capable of projecting the image formed by the imager onto a viewing surface, and a polarizing element that is disposed between the imager and the projection lens system. The polarizing element is capable of directing light of a first polarization toward the imager and light of a second polarization different from the first polarization away from the imager. The projection system further includes a color filter that is disposed between the polarizing element and the projection lens system. The color filter is polarization insensitive in the visible and is capable of changing a color coordinate of light incident on the color filter.

### BRIEF DESCRIPTION OF DRAWINGS

The invention may be more completely understood and appreciated in consideration of the following detailed description of various embodiments of the invention in connection with the accompanying drawings, in which:

FIG. 1 is a schematic three-dimensional view of an optical configuration for describing different polarization states;

FIG. 2 is a schematic top-view of an optical system;

FIG. 3 is a schematic top-view of another optical system;

FIG. 4A is a schematic plot of optical transmittance as a function of wavelength for a long wave pass color filter;

FIG. 4B is a schematic plot of optical transmittance as a function of wavelength for a short wave pass color filter;

FIG. 4C is a schematic plot of optical transmittance as a function of wavelength for a band pass color filter; and

FIG. 5 is a schematic of a projection system.

### DETAILED DESCRIPTION

The present invention generally relates to projection engines and projection systems incorporating the same. The invention is particularly applicable to projection systems having one or more telecentric spaces and which incorporate color correcting components.

In the specification, a same reference numeral used in multiple figures refers to the same or similar elements having the same or similar properties and functionalities.

The present invention describes a simplified projection system capable of projecting an image onto a screen where the projected image has uniform color across the screen. The color uniformity is achieved by placing a color filter in an easily accessible telecentric space of the projection system, thereby simplifying the design and manufacturing cost of the projection system. The color filter is further positioned to eliminate, minimize, or reduce ghost images that can otherwise appear on the screen due to reflection of light from the color filter.

A used herein, the term “telecentric” means that the angular range of the light is substantially the same for different points across the beam. Thus, if a portion of the beam at one side of the beam contains light in a light cone having a particular angular range, then other portions of the beam, for example at the middle of the beam and at the other side of the beam, contain light in substantially the same angular range. Consequently, the light beam is telecentric if light at the center of the beam is directed primarily along an axis and is contained within a particular cone angle while light at the edges of the beam is also directed along the axis and has substantially the same cone angle.

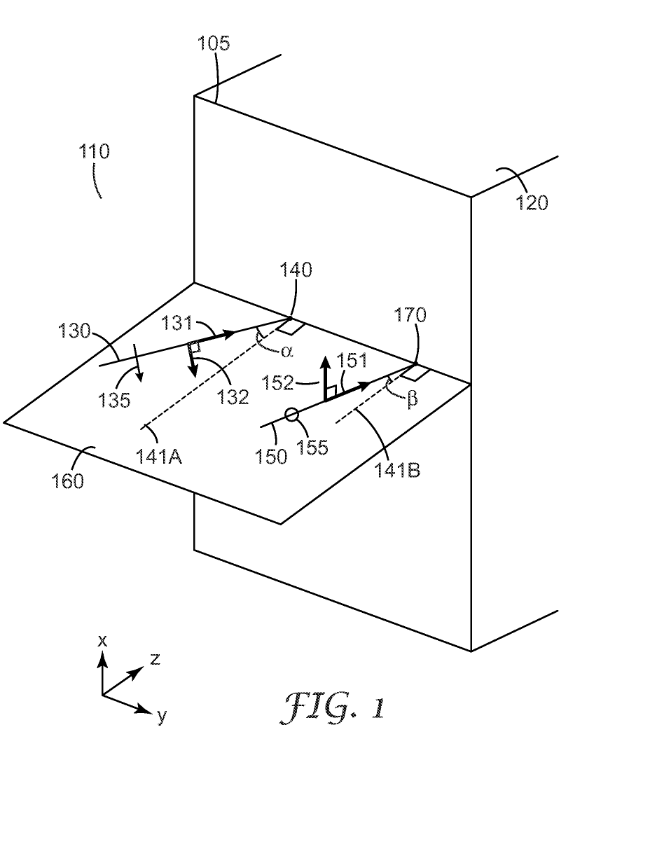

FIG. 1 shows a schematic three-dimensional view of an optical configuration for the purpose of describing s- and p-polarization states of a linearly polarized light. In particular, FIG. 1 shows an interface 105 between a first medium 110 having an index of refraction n₁ and a second medium 120 having an index of refraction n₂. A linearly polarized light ray 130 propagating along direction 131 is incident on interface 105 at location 140 and makes an incident angle α with normal line 141A, where line 141 is perpendicular to interface 105 at location 140. Propagation direction 131 and normal line 141 define a plane of incidence 160 for incident light ray 130. As shown in FIG. 1, light ray 130 is p-polarized since electric field 132 associated with light ray 130 lies in and is, therefore, parallel to plane of incidence 160. In the specification, a p-polarization state is symbolically represented by a small arrow, such as arrow 135 shown in FIG. 1.

Similarly, linearly polarized light ray 150 propagates along direction 151 in plane 160, is incident on interface 105 at location 170, and makes an incident angle β with normal line 141B. Light ray 150 is s-polarized since electric field 152 associated with light ray 150 is perpendicular to plane of incidence 160. In the specification, an s-polarization state is symbolically represented by a small circle, such as circle 155 shown in FIG. 1.

In general, a light ray incident on a surface at a point defines a plane of incidence defined by the ray and the normal to the surface at the point of incidence. For a linearly polarized incident light ray the polarization will in general have an s-polarization component or state that is perpendicular to the plane of incidence and a p-polarization component or state that is parallel to the plane of incidence. The s-polarization is sometimes referred to as the transverse electric (TE) polarization. Similarly, the p-polarization is sometimes referred to as the transverse magnetic (TM) polarization. It will be appreciated from FIG. 1 and the preceding discussion that s- and p-polarization states are orthogonal to one another.

In FIG. 1, different polarization states are described in terms of their orientation relative to the plane of incidence. In some cases, it may be advantageous to define a polarization state in relation to a coordinate system, such as the xyz Cartesian coordinate system shown in FIG. 1. In this case, a first polarization state with the electric filed oriented along the x-axis may be defined as an x-polarization state. Similarly, a second polarization state with an electric filed oriented along the y-axis, which is orthogonal to the first polarization state, may be defined as the y-polarization state.

An advantage of defining a polarization state in relation to a coordinate system is that the coordinate system can be defined in reference to the principal axes of an element, such as a polarizer, in an optical system independent of the plane and/or angle of incidence. An example of an optical system where different polarization states are defined in reference to a Cartesian coordinate system can found in U.S. Pat. No. 6,486,997.

In general, a p- or an s-polarization state need not be identical to an x- or y-polarization state in a Cartesian coordinate system. In some cases, however, a p- or an s-polarization may be the same as an x- or y-polarization state in a Cartesian coordinate system. For example, electric field 152 is both s- and x-polarized since electric field 152 is oriented along the x-axis. As another example, electric field 132 is p-polarized, but it is not purely x- or y-polarized since the electric field is parallel neither to the x-axis nor to the y-axis. Rather, electric field 132 is partly x-polarized and partly y-polarized.

It will be appreciated that any reference to a polarization state in a particular reference system, such as a p-polarization state in reference to a plane of incidence, is intended to be exemplary and not limiting in any manner. In particular, inferences to various polarization states in a reference system are intended to equivalently apply to other reference systems.

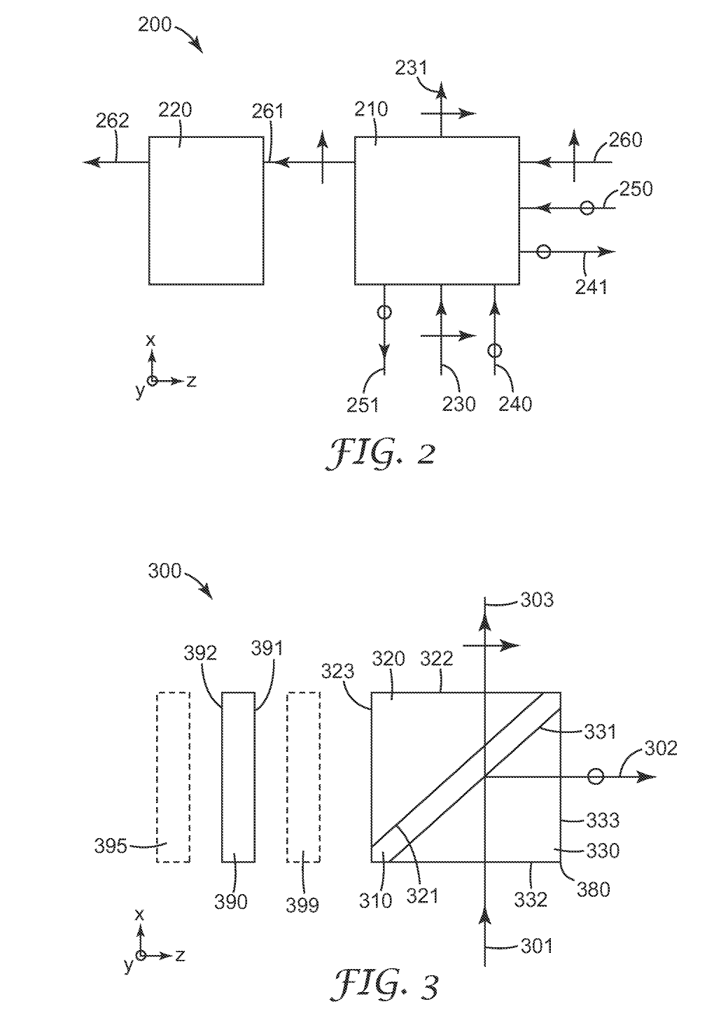

FIG. 2 shows a schematic top-view of an optical system 200. Optical system 200 includes a first optical element 210 and a second optical element 220. First optical element 210 transmits visible light of one polarization and reflects visible light of an orthogonal polarization. In particular, a p-polarized visible light ray 230 that propagates along the x-axis and is incident on optical element 210 is substantially transmitted by optical element 210 as a p-polarized visible light ray 231 propagating along the x-axis. Therefore, for an incident p-polarized light the direction of the transmitted light is substantially the same as the direction of the incident light.

In some applications, the ratio of the intensity of transmitted light ray 231 to the intensity of incident light ray 230 is at least 0.50. In some other applications, the ratio is at least 0.80. In some other applications, the ratio is at least 0.90.

An s-polarized visible light ray 240 that propagates along the x-axis and is incident on optical element 210 is substantially reflected by optical element 210 as an s-polarized visible light ray 241 propagating along the z-axis. Therefore, for an incident s-polarized visible light the direction of the reflected light is different from the direction of the incident light.

In some applications, the ratio of the intensity of reflected light ray 241 to the intensity of incident light ray 240 is at least 0.50. In some other applications, the ratio is at least 0.80. In some other applications, the ratio is at least 0.90.

Similarly, an s-polarized visible light ray 250 that propagates along the z-axis and is incident on optical element 210 is substantially reflected by optical element 210 as an s-polarized visible light ray 251 propagating along the x-axis.

A p-polarized visible light ray 260 that propagates along the z-axis and is incident on optical element 210 is substantially transmitted by optical element 210 as a p-polarized visible light ray 261 propagating along the z-axis. Light ray 261 has a first color. For example, light ray 261 has color coordinates (x₁, y₁) in the CIE color coordinate space, where x₁ is the x chromaticity coordinate in the CIE diagram and y₁ is the y chromaticity coordinate in the CIE diagram.

Light ray 261 is incident on optical element 220 and is transmitted by the optical element as transmitted visible light ray 262 propagating along the z-direction having a second color different from the first color. For example, the second color has color coordinates (x₂, y₂), where y₁ and y₂ are equal but x₂ is different from x₁, x₁ and x₂ are equal but y₂ is different from y₁, or x₁ is different from x₂ and y₂ is different from y₁.

In general, transmitted light ray 262 can have any state of polarization. In some cases, optical element 220 substantially maintains the polarization state of an incident light upon transmission. In such cases, transmitted light ray 262 would be substantially p-polarized.

In the exemplary optical system 200, incident light rays are parallel to corresponding transmitted light rays and orthogonal to corresponding reflected light rays. In general, a transmitted light ray may or may not be parallel to a corresponding incident light ray. Similarly, a reflected light ray may or may not be orthogonal to a corresponding incident light ray.

FIG. 3 shows a schematic top-view of an optical system 300. Optical system 300 includes a polarizing beam splitter (PBS) 380 as a particular example of optical element 210 and a color filter 390 as a specific example of optical element 220.

PBS 380 can be any type of PBS that may be suitable in an application. For example, PBS 380 can be a MacNeille-type PBS described in, for example, U.S. Pat. No. 2,403,731; and H. A. Macleod, Thin Film Optical Filters, 2nd Edition, McGraw-Hill Publishing Co., 1989; pp. 328-332. As another example, PBS 380 can be a multilayer optical film (MOF) PBS, such as an MZIP PBS described in U.S. Pat. Nos. 5,962,114 and 6,721,096. Other suitable types of PBS include a wire grid PBS described in, for example, Schnabel et al., “Study on Polarizing Visible Light by Subwavelength-Period Metal-Stripe Gratings”, Optical Engineering 38(2), pp. 220-226, February 1999. As yet another example, PBS 380 can be based on a cholesteric polarizer described, for example, in U.S. Pat. No. 5,506,704. In some cases, PBS 380 can be a Cartesian PBS having fixed material axes of polarization. In such cases, the polarization state of incident light 301 may be defined in reference to the material axes of PBS 380 rather than to the traditional p- and s-axes.

In the exemplary optical system shown in FIG. 3, PBS 380 includes two right angled prisms 320 and 330 and a reflecting polarizer 310 disposed between hypotenuse faces 321 and 331 of the two prisms. In general, prisms 320 and 330 need not be the same size, same shape, or be made of the same material. Furthermore, each prism may have a shape other than the right-angled prisms shown in FIG. 3. Examples of the type of prisms or optical bodies that can be used in place of prisms 320 and 330 include prisms used in a Rochon PBS, a Wollaston PBS, a Glan-Taylor PBS, a Glan-Thompson PBS, a Glan-Foucault prism, or a Nicol PBS. In general, prisms 320 and 330 can be any optical body that may be desirable in an application and which, combined with reflective polarizer 310, is capable of effectively dividing an unpolarized incident light, such as incident light 301, into two orthogonally polarized light beams such as s-polarized light beam 302 and p-polarized light beam 303.

In some cases, at least one of prisms 320 and 330 may not be needed and, therefore, may be eliminated from optical system 300. For example, in the case of a wire grid PBS, prisms 320 and 330 may be eliminated from optical system 300. In such a case, the wire grid polarizer may be formed on or supported by a light transmissive substrate, such as a glass or polymeric substrate.

Reflecting polarizer 310 is capable of reflecting light of one polarization state and transmitting light of an orthogonal polarization state. In the exemplary optical system shown in FIG. 3, reflecting polarizer 310 is capable of substantially reflecting s-polarized light and substantially transmitting p-polarized light. Equivalently, for ray 301, reflecting polarizer 310 is capable of substantially reflecting y-polarized light and substantially transmitting z-polarized light. Furthermore, reflective polarizer 310 is so positioned and the faces of prisms 320 and 330 are so arranged as to make PBS 380 capable of dividing an incident unpolarized light into two orthogonally polarized beams propagating at 90° relative to each other.

In the exemplary optical system shown in FIG. 3, sides 322 and 323 of prism 320 are parallel to yz- and xy-planes, respectively. Similarly, sides 332 and 333 of prism 330 are parallel to yz- and xy-planes, respectively. Furthermore, hypotenuse faces 321 and 331 are parallel to each other and make a 45° angle with the z-axis. In such a case, when an incident unpolarized light beam 301 is incident on PBS 380 along the x-axis, the s-polarized component of the incident beam is reflected as light beam 302 propagating along the z-direction and the p-polarized component of the incident beam is transmitted as light beam 303 propagating along the x-direction.

Color filter 390 is capable of substantially transmitting a first range of wavelengths in the visible and substantially blocking or rejecting a second range of wavelengths in the visible by, for example, absorbing or reflecting light with wavelengths in the second range. The first and second ranges can, for example, include ranges from λₘ to λₙ and from λₖ to λₕ, respectively.

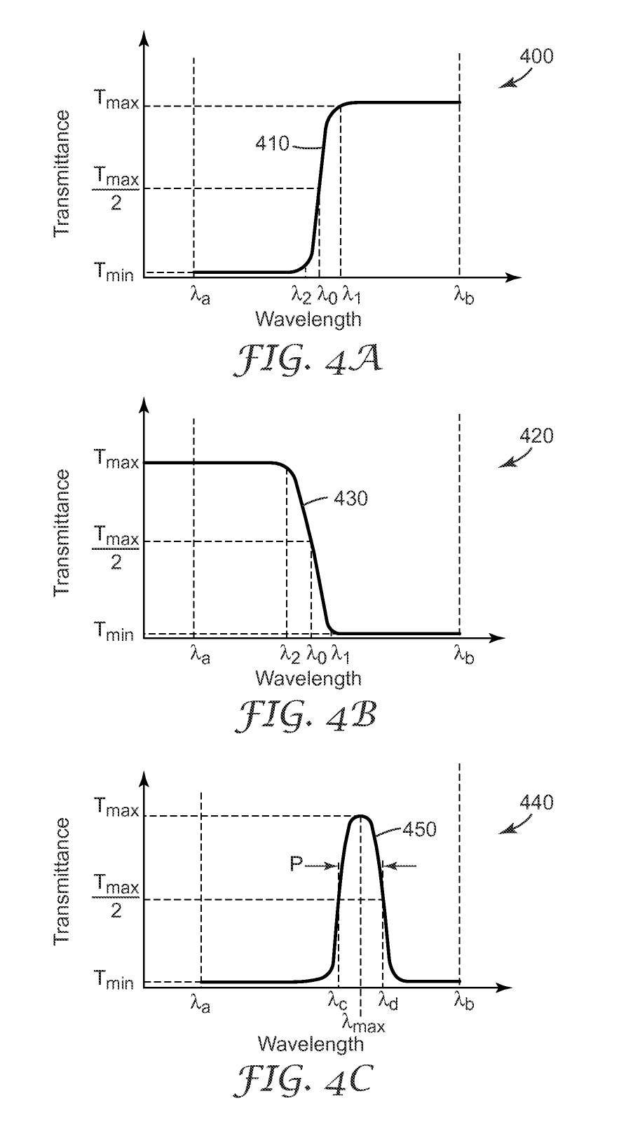

Color filter 390 can be a long wave pass (LWP) edge filter, as shown schematically in plot 400 of FIG. 4A and available commercially from, for example, Oerlikon Balzers Corp. (Balzers, Liechtenstein). The horizontal axis in plot 400 is wavelength and the vertical axis is transmittance. The wavelength range λₐ to λ_{b} represent the visible range with λₐ representing the blue end of the visible spectrum and λ_{b} representing the red end of the visible spectrum. Curve 410 in plot 400 represents transmittance of color filter 390 as a function of wavelength. Color filter 390 has very high average transmittance Tₘₐₓ for wavelengths larger than λ₁ in the visible and very low average transmittance Tₘᵢₙ for wavelengths less than λ₂ in the visible. Wavelengths λ₁ and λ₂ can each be defined in different ways. For example, λ₁ can be defined as the wavelength at which the transmittance of color filter 390 is 10%, or 5%, less than Tₘₐₓ. Similarly, λ₂ can be defined as the wavelength at which the transmittance of color filter 390 is 10%, or 5%, greater than Tₘᵢₙ.

Curve 410 shows a transition range for the transmittance of color filter 390 between wavelengths λ₂ and λ₁, within which the transmittance increases at a rate approximately equal to ΔT/Δλ where ΔT=Tₘₐₓ−Tₘᵢₙ and Δλ=λ₁−λ₂. The transition range has a center wavelength λₒ typically defined as the wavelength at which the transmittance is Tₘₐₓ/2.

In some applications, Tₘₐₓ is at least 50%. In some other applications, Tₘₐₓ is at least 70%. In some other applications, Tₘₐₓ is at least 80%. In yet some other applications, Tₘₐₓ is at least 90%. In some applications, Tₘₐₓ is at most 20%. In some other applications, Tₘᵢₙ is at most 10%. In yet some other applications, Tₘᵢₙ is at most 5%.

In some applications, transition range Δλ is at most 100 nanometers. In some other applications, transition range Δλ is at most 50 nanometers. In some other applications, transition range Δλ is at most 10 nanometers.

In the exemplary plot 410 shown in FIG. 4A, the range λₘ to λₙ can correspond to the wavelength interval λ₁-λ_{b}, and the wavelength range λₖ to λₕ can correspond to the wavelength interval λₐ-λ₂.

Color filter 390 can be a short wave pass (SWP) edge filter shown schematically in plot 420 of FIG. 4B. Curve 430 in plot 420 represents transmittance of color filter 390 as a function of wavelength. Color filter 390 has a high average transmittance Tₘₐₓ for wavelengths less than λ₂ in the visible and a low average transmittance Tₘᵢₙ for wavelengths larger than λ₁ in the visible. In the exemplary plot 420 shown in FIG. 4B, the range λₘ to λₙ can correspond to the wavelength interval λₐ-λ₂, and the wavelength range λₖ to λₕ can correspond to the wavelength interval λ₁-λ_{b}.

As another example, color filter 390 can be a band-pass filter having high optical transmittance for wavelengths within a wavelength band in the visible and low optical transmittance for wavelengths outside the band in the visible. An exemplary transmittance of a band pass color filter 390 is schematically shown in plot 440 of FIG. 4C. Curve 450 in plot 440 represents transmittance of color filter 390 as a function of wavelength. Color filter 390 has a maximum optical transmittance Tₘₐₓ at λₘₐₓ, where λₘₐₓ is sometimes referred to as the center wavelength of the color filter. Pass-band “P” is defined as the high transmittance region between λ_{c} and λ_{d}, where λ_{c} and λ_{d} are typically defined as the wavelengths at which the transmittance is Tₘₐₓ/2. Wavelengths λ_{c} and λ_{d} are sometimes referred to as the cut off wavelengths.

In the exemplary plot 440 shown in FIG. 4C, the range λₘ to λₙ can correspond to the wavelength interval λ_{c}-λ_{d}, and the wavelength range λₖ to λₕ can correspond to the wavelength intervals λₐ-λ_{c} and λ_{d}-λ_{b}.

In some applications, a band-pass color filter 390 can be a narrow band-pass color filter, meaning that pass-band P is relatively small, such as about 50 nanometers. In some other applications, a band-pass color filter 390 can be a wide band-pass color filter, meaning that pass-band P is relatively large, such as 200 nanometers.

Color filter 390 can be a light reflecting color filter or a light absorbing color filter or a combination of the two. Such filters are commercially available from, for example, Hoya Corp., San Jose, Calif. In some applications, color filter 390 is a light absorbing color filter, meaning that the filter blocks or rejects light at a wavelength in the visible by primarily absorbing the light. An absorbing color filter can be made by, for example, dispersing one or more organic dyes or pigments in a host material as discussed, for example, in U.S. Pat. No. 6,426,590.

In some applications, color filter 390 is a light reflecting color filter, meaning that the filter blocks or rejects light at a wavelength in the visible by primarily reflecting the light. A light reflecting color filter 390 can, for example, be a multilayer dielectric interference color filter such as a quarter-wave stack, a cholesteric liquid crystal layer, a holographic color filter, or a Bragg reflector constructed of birefringent polymers described in, for example, Weber et al., “Giant Birefringent Optics in Multilayer Polymer Mirrors”, Science 287(5462), pp. 2451-2456, March 2000.

In the case of a reflecting color filter, the transmittance curve of the color filter typically shifts to shorter wavelengths with increasing angle of incidence as measured from the normal to the surface on which the light is incident. Light absorbing color filters, on the other hand, are typically insensitive to angle of incidence.

Color filter 390 may or may not be sensitive to the polarization state of an incident light. In some cases, color filter 390 is polarization insensitive, meaning that transmittance properties of the color filter, such as the high and low transmittance ranges, are substantially insensitive to the polarization state of an incident light at least at normal incidence. In such cases, the transmittance properties of the color filter are substantially the same for an incident light ray with one state of polarization and an incident light ray with an orthogonal state of polarization. For example, transmittance properties of the color filter are substantially the same for s- or p-polarized incident light at a same wavelength.

In some cases, color filter 390 may be polarization sensitive. In such cases, transmittance properties of the color filter may be different for s- and p-polarized incident light at a same wavelength. For example, color filter 390 may be capable of substantially transmitting a range of wavelengths in the visible for an incident p-polarized light and substantially blocking or rejecting the same range of wavelengths in the visible for an incident s-polarized light.

In the exemplary optical system of FIG. 3, color filter 390 and PBS 380 are spaced apart. In general, there may or may not be a gap between the two. In some applications, color filter 390 may be disposed on a side, such as side 323, of the PBS. For example, color filter 390 may be a quarter-wave stack color filter formed directly on side 323 by, for example, using a vacuum based coating process, such as a sputtering process. As another example, filter 390 may be a light absorbing color filter formed directly on side 323 by coating the side with a host material containing organic dyes or pigments for providing optical absorption. As yet another example, color filter 390 may be laminated to side 323 by using, for example, an optical adhesive.

In some applications, color filter 390 may be disposed between hypotenuse faces 321 and 331. In such cases, color filter 390 may substantially transmit a first range of wavelengths in the visible for an incident p-polarized light and substantially block a second range of wavelengths in the visible for an incident p-polarized light.

In some cases, a polarization sensitive color filter 390 disposed between hypotenuse faces 321 and 331 may have different wavelength band edge shifts for p- and s-polarized light. In such cases, color filter 390 may be selected so that the color filter has the desired transmission and band edge properties for p-incident light.

Optical system 300 can include other optical elements. For example, one or more optical elements, such as optical elements 395 and 399 may be disposed on either side of color filter 390, where optical element 399 faces a first major surface 391 of color filter 390 and optical element 395 faces a second major surface 392 of color filter 390. Optical elements 395 and 399 can, for example, be retarder films.

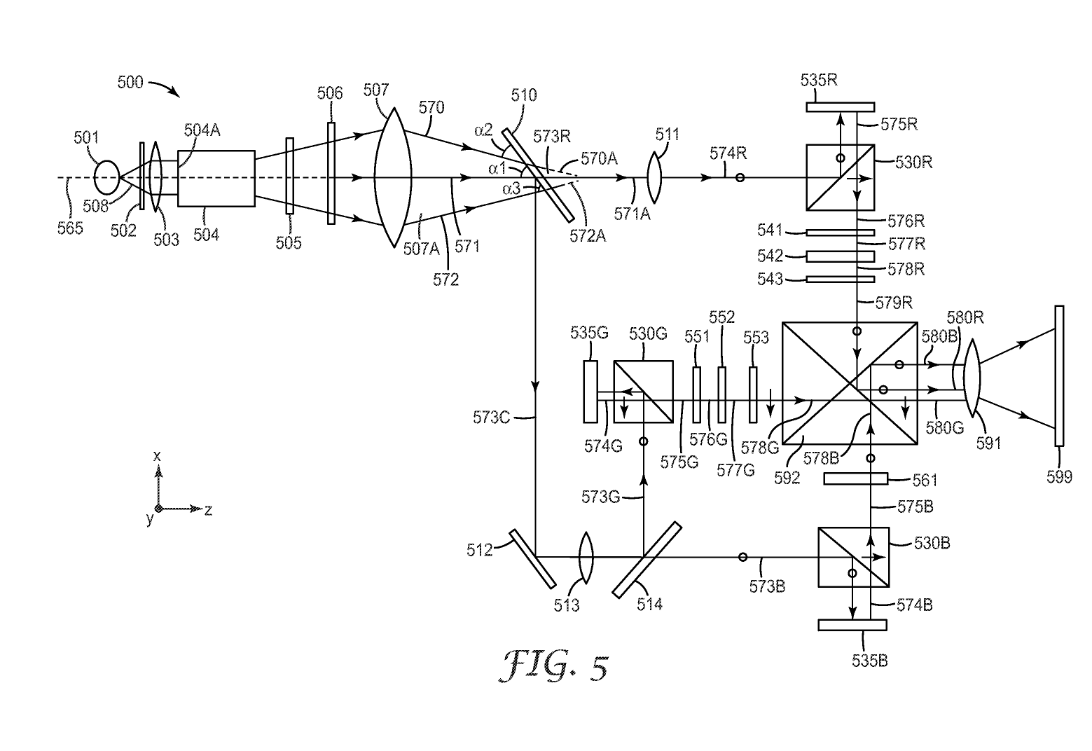

FIG. 5 schematically illustrates an exemplary multi-panel projection system 500. Projection system 500 is a three-panel projection system, having imagers 535B, 535G, and 535R, where the three imagers are designed to operate in different color bands, such as the three primary colors blue, green, and red.

Projection system 500 can be viewed as having three channels, each including a different imager and operating in a different color band. For example, the first channel includes imager 535R, PBS 530R, retarders 541 and 543, and color filter 542. The second channel includes imager 535G, PBS 530G, retarders 551 and 553, and color filter 552. Similarly, the third channel includes imager 535B, PBS 530B, and retarder 561.

In some applications, the first channel is the red channel, the second channel is the green channel, and the third channel is the blue channel. In general, the different channels can be associated with different colors.

Projection system 500 further includes a light source 501 capable of emitting light that contains light in three different color bands. In particular, light source 501 can emit light that contains light in the blue, green, and red regions of the spectrum. Light source 501 can, for example, include an arc lamp such as a mercury arc lamp, an incandescent lamp, a fluorescent lamp, a light emitting diode (LED), or any other light source capable of emitting light in different color bands.

Light source 501 can be a single light source. In some applications, light source 501 can include multiple light sources where, for example, different light sources can emit different color light.

Projection system 500 further includes UV blockers 502 and 505, lens 503, light homogenizer 504, pre-polarizer 506, and condenser lens 507. UV blockers 502 and 505 are primarily designed to reject any UV radiation that may be emitted by light source 501. UV blockers 502 and 503 may be rejecting UV radiation by absorption, reflection, or a combination of the two.

Lens 503 collects light 508 and directs it toward entrance face 504A of light homogenizer 504. In some cases, lens 503 may be replaced or supplemented by a reflector (not shown in FIG. 5), such as a curved reflector, placed behind light source 501 for directing light 508 toward entrance face 504A. Homogenizer 504 is primarily designed to homogenize light that is collected and transmitted by lens 503, where by homogenizing it is meant that light exiting the homogenizer has a more uniform spatial intensity distribution than light entering the homogenizer. Examples of known light homogenizers may be found in U.S. Pat. Nos. 5,625,738 and 6,332,688; and U.S. Patent Application Publication Nos. 2002/0114167, 2002/0114573, and 2002/0118946.

Pre-polarizer 506 is primarily designed to polarize light that is incident on the pre-polarizer. For example, pre-polarizer 506 rejects p-polarized light and transmits s-polarized light. The rejected p-polarized light may be recycled by one or more polarization recycling elements not explicitly shown in FIG. 5. Pre-polarizer 506 may reject p-polarized light by absorption, reflection, or a combination of the two. Pre-polarizer 506 may be a reflective polarizer such as a wire grid polarizer, such as those described in U.S. Pat. No. 6,288,840, or a multilayer reflective polarizer, such as a polymeric multilayer reflective polarizing film described in, for example, U.S. Pat. No. 5,612,820. Pre-polarizer 506 may be a light absorbing polarizer such as a dichroic absorber. Pre-polarizer 506 can be a linear polarizer or a circular polarizer, such as a cholesteric polarizer described in U.S. Pat. No. 5,506,704 combined with, for example, a retarder, such as a quarter-wave retarder.

Condenser lens 507 concentrates light that is pre-polarized by pre-polarizer 506 into light beam 507A and directs it toward color separators 510 and 514. Color separators 510 and 514 are designed to split light 507A into first, second, and third light beams 573B, 573G, and 573R each containing light of a different color. Light beams 573B, 573G, and 573R may be, for example, blue, green, and red in color, respectively. For example, color separator 510 splits incident white light 507A into red light beam 573R and cyan light beam 573C where cyan light beam 573C contains green and blue light. Similarly, color separator 514 splits cyan light beam 573C into blue light beam 573B and green light beam 573G.

In general, color separators 510 and 514 are dichroic mirrors each including a multilayer interference film capable of reflecting light in a specific region in the visible and transmitting light elsewhere in the visible. The transmittance and reflectance properties of a multilayer interference film generally change with angle of incidence which can lead to, for example, a transmitted light beam in which light rays propagating along different directions have different color coordinates. For example, color separator 510 may make a 45° angle with the x-axis and may be designed to receive light at 45° incident angle. In such a case, light ray 571 of light beam 507A makes an angle α₁=45° with the color separator, resulting in a transmitted light ray 571A that has a desired set of color coordinates in the red region of the visible spectrum. Light ray 570 of light beam 507A, however, makes an angle α₂ smaller than α₁ with color separator 510, resulting in a transmitted light ray 570A that is red-shifted relative to light ray 571A. Similarly, light ray 572 of light beam 507A makes an angle α₃ larger than α₁ with color separator 510, resulting in a transmitted light ray 572A that is blue-shifted relative to light ray 571A. Accordingly, different light rays in transmitted light beam 573R have different red color coordinates which can result in color non-uniformity across a projected image. The color non-uniformity can be particularly substantial where color separator 510 and light beam 507A are located in a non-telecentric space of projection system 500.

Similarly, different light rays in reflected cyan light beam 573C have different cyan color coordinates because different light rays in light beam 573C have different green content.

Projection system 500 further includes a mirror 512 for bending and directing light beam 573C toward color separator 514, and a projection lens 591 for projecting an image formed by the imagers onto a projection screen 599.

Projection system 500 further includes lenses 511 and 513. Lens 511 produces a transmitted telecentric light beam 574R and a telecentric space between lens 511 and projection lens 591 where the telecentric space is along the optical train between lenses 511 and 591. Similarly, lens 513 creates telecentric light beams 573B and 573G and a telecentric space between lens 513 and projection lens 599.

Color separator 514 is positioned in a telecentric space of projection system 500. Accordingly, color separator 514 does not introduce any additional color non-uniformity when splitting light beam 573C into light beams 573B and 573G. In the exemplary case where light beams 573B, 573G, and 573R are blue, green, and red, respectively, some different light rays in red light beam 573R have different red color coordinates, some different light rays in green light beam 573G have different green color coordinates, but the light rays in blue light beam 573B have substantially the same blue color coordinates.

Polarizing beam splitters 530B, 530G, and 530R are similar to PBS 380. For example, polarizing beam splitters 530B, 530G, and 530R each substantially transmits p-polarized light and substantially reflects s-polarized light.

In the red channel and for an on-state pixel, s-polarized red light beam 574R is incident on imager 535R after being reflected by PBS 530R. The imager modulates and reflects the incident light as p-polarized red light beam 575R. PBS 530R transmits the p-polarized light beam 575R as p-polarized light beam 576R. Retarders 541 and 543 change the polarization of light beam 576R resulting in an s-polarized light beam 579R entering combiner 592. In some cases, each of the two retarders 541 and 543 is a quarter-wave retarder in the red region of the spectrum.

Color filter 542 is similar to second optical element 220 of FIG. 2 and color filter 390 of FIG. 3. Color filter 542 is positioned in a telecentric space of projection system 500 and eliminates or reduces color non-uniformity that exists amongst different red light rays in red light beam 576R. In some cases, light beam 578R transmitted by color filter 542 has a set of color coordinates that is different from a corresponding set of color coordinates of incident light beam 577R.

In the exemplary projection system shown in FIG. 5, color filter 542 is disposed between two retarders 541 and 543, where each retarder can be a quarter-wave retarder. In general, any number of retarders may be used where the combined effect is half-wave retardation changing the polarization state of light beam 576R from p to s. For example, in some applications, a single half-wave retarder may be used in place of retarders 541 and 543. An advantage of placing color filter 542 between two quarter-wave retarders is that any light that may be reflected by color filter 542, such as in the case where color filter 542 is a reflective color filter, passes through quarter-wave retarder 541 resulting in an s-polarized light that is reflected by PBS 530R along the positive z-direction away from imager 535R.

In some cases, PBS 530R is a Cartesian PBS. In cases where PBS 530R has high extinction for skew rays, projection system 500 can function at low f/#s. As the f/# in projection system 500 is reduced, ray 570 becomes more red-shifted upon transmission through color separator 510 because angle α₁ becomes smaller, and ray 572 becomes more blue-shifted upon transmission through color separator 510 because angle α₃ becomes larger. In such cases, the use of color filter 542 is especially advantageous since the color non-uniformity in the absence of color filter 542 can be large and unacceptable.

In the green channel and for an on-state pixel, s-polarized green light beam 573G is incident on imager 535G after being reflected by PBS 530G. The imager modulates and reflects the incident light as p-polarized green light beam 574G. PBS 530G transmits the p-polarized light beam 574G as p-polarized 575G. Retarders 551 and 553 combine to maintain the polarization of light beam 575G resulting in a p-polarized light beam 578G entering combiner 592. In some cases, retarder 551 is a quarter-wave retarder in the green region of the spectrum and retarder 553 is a three-quarter-wave retarder in the green region of the spectrum.

Color filter 552 is similar to second optical element 220 of FIG. 2 and color filter 390 of FIG. 3. Color filter 552 is positioned in a telecentric space of projection system 500 and eliminates or reduces color non-uniformity that exists amongst different green light rays in green light beam 575G. In some cases, light beam 577G transmitted by color filter 552 has a set of color coordinates that is different from a corresponding set of color coordinates of incident light beam 576G.

In the exemplary projection system shown in FIG. 5, color filter 552 is disposed between two retarders 551 and 553, where retarder 551 can be a quarter-wave retarder and retarder 553 can be a three-quarter-wave retarder. In general, any number of retarders may be used where the combined effect is a full-wave retardation preserving the polarization state of light beam 575G as p. An advantage of placing color filter 542 between a quarter-wave retarder and a three-quarter-wave retarder is that any light that may be reflected by color filter 552 passes through quarter-wave retarder 551 resulting in an s-polarized light that is reflected by PBS 530G in the positive x-direction away from imager 535G. In some cases, it may be desirable for light 578G to be s-polarized. In such cases, retarder 553 can, for example, be a quarter-wave retarder.

In the blue channel and for an on-state pixel, s-polarized blue light beam 573B is incident on imager 535B after being reflected by PBS 530B. The imager modulates and reflects the incident light as p-polarized blue light beam 574B. PBS 530B transmits the p-polarized light beam 574B as p-polarized 575B. Retarder 561 changes the polarization of light beam 575B resulting in an s-polarized light beam 578B entering combiner 592. In some applications, retarder 561 is a half-wave retarder.

In general, a quarter-wave retarder in projection system 500 can have any orientation relative to the y-axis that may be desirable in an application. In some cases, a quarter-wave retarder in projection system 500, such as quarter wave retarders 541 and 543, may be oriented at 45° relative to the y-axis.

An advantage of the present invention is that color filters 542 and 552 are each placed in a telecentric space, between a corresponding PBS and projection lens 591. In some cases, color filters 542 and 552 are each normal to optical axis 565. Such a placement provides for a more compact arrangement of the optical components with no or little ghosting due to undesired reflections.

In some cases, projection system 500 can function at f/#s equal to or less than f/4.0. In some other cases, projection system 500 can function at f/#s equal to or less than f/3.0. In some other cases, projection system 500 can function at f/#s equal to or less than f/2.5.

Color combiner 592 is, in general, designed to combine image light beams reflected by the imagers in the projection system and deliver the combined light to projection lens 591 for projection onto projection screen 599. In the exemplary projection system shown in FIG. 5, combiner 592 is designed to combine three different colors, two of which are s-polarized and a third of which is p-polarized. In particular, combiner 592 combines s-polarized red image light beam 579R, s-polarized blue image light beam 578B, and p-polarized green image light beam 578G and outputs overlapping light beams 580R from the red channel, 580B from the blue channel, and 580G from the green channel.

In some applications, color combiner 592 may be designed to combine three different colors all of which are s-polarized or all of which are p-polarized.

In the exemplary projection system shown in FIG. 5, color combiner 592 is an x-cube color combiner, but other types of combiner may be used. Projection lens 591 can include one or more lens elements that are used for projecting the combined image light beam onto screen 599.

In general, projection system 500 may have fewer or more imagers than three. For example, projection system 500 may have one or two image-forming devices, with respective PBSs, described in greater detail in, for example, U.S. patent application Ser. Nos. 10/439,449 and 10/914,596.

All patents, patent applications, and other publications cited above are incorporated by reference into this document as if reproduced in full. While specific examples of the invention are described in detail above to facilitate explanation of various aspects of the invention, it should be understood that the intention is not to limit the invention to the specifics of the examples. Rather, the intention is to cover all modifications, embodiments, and alternatives falling within the spirit and scope of the invention as defined by the appended claims.

What is claimed is:

1. An optical system comprising first and second optical elements, the second optical element being polarization insensitive in the visible, the first optical element being capable of
receiving light of a first polarization along a first direction and transmitting the same along the first direction, and
receiving light of a second polarization orthogonal to the first polarization along the first direction and reflecting the same along a second direction different from the first direction,
such that when the optical system receives light of the first polarization along the second direction, the first optical element transmits the received light along the second direction, the light transmitted by the first optical element having the first polarization and a first set of color coordinates, and the second optical element transmits at least a portion of the light transmitted by the first optical element, the light transmitted by the second optical element having a second set of color coordinates different from the first set of color coordinates.

2. The optical system of claim 1, wherein the first optical element is a multilayer optical film.

3. The optical system of claim 1, wherein the first optical element is a wire grid.

4. The optical system of claim 1, wherein the visible range is from about 420 nanometers to about 680 nanometers.

5. The optical system of claim 1, wherein the first direction is substantially normal to the second direction.

6. The optical system of claim 1, wherein the second optical element is an edge color filter, the edge being located in the visible.

7. The optical system of claim 1, wherein the second optical element is located in a telecentric space of the optical system.

8. The optical system of claim 1, wherein at least one chief light ray in the optical system is normally incident onto the second optical element.

9. The optical system of claim 1, wherein the second set of color coordinates is red-shifted relative to the first set of color coordinates.

10. The optical system of claim 1 further comprising at least one retarder disposed adjacent the second optical element.

11. The optical system of claim 1 further comprising two retarders, the second optical element being disposed between the two retarders.

12. The optical system of claim 11, wherein at least one of the two retarders is a quarter-wave retarder in the visible.

13. The optical system of claim 11, wherein at least one of the two retarders is a quarter-wave retarder in a primary color region of the spectrum.

14. The optical system of claim 11, wherein both retarders are quarter-wave retarders in the visible.

15. The optical system of claim 14, wherein both retarders are quarter-wave retarders in the blue region of the spectrum.

16. The optical system of claim 14, wherein both retarders are quarter-wave retarders in the red region of the spectrum.

17. The optical system of claim 11, wherein one retarder is a quarter-wave retarder in the visible and the other retarder is a three-quarter-wave retarder in the visible.

18. The optical system of claim 11, wherein one retarder is a quarter-wave retarder in the red region of the spectrum and the other retarder is a three-quarter-wave retarder in the red region of the spectrum.

19. A projection system comprising the optical system of claim 1.

20. The projection system of claim 19, wherein the optical system is in a telecentric space of the projection system.

21. A polarizing beam splitter comprising:
a first optical component having a first face;
a second optical component having a first face;
a polarizing element disposed between the first faces of the first and second optical components, the polarizing element being capable of transmitting light of a first polarization and reflecting light of a second polarization, the second polarization being orthogonal to the first polarization; and
a color filter disposed on a face of one of the first and second optical components, the color filter being polarization insensitive in the visible and capable of changing a color coordinate of light incident on the color filter.

22. The polarizing beam splitter of claim 21, wherein at least one of the first and second optical components is a prism.

23. The polarizing beam splitter of claim 21, wherein the polarizing element is a multilayer optical film.

24. The polarizing beam splitter of claim 21, wherein the polarizing element is a wire grid.

25. The polarizing beam splitter of claim 21, wherein the polarizing element is in contact with both first faces of the first and second optical components.

26. The polarizing beam splitter of claim 21, wherein the color filter is an edge color filter.

27. The polarizing beam splitter of claim 21, wherein the color filter is disposed between the first faces of the first and second optical components.

28. The polarizing beam splitter of claim 21, wherein the face the color filter is disposed on is different than the first faces of the first and second optical components.

29. The polarizing beam splitter of claim 21 further comprising at least one retarder disposed on a face of one of the first and second optical components.

30. A projection system comprising the polarizing beam splitter of claim 21.

31. The projection system of claim 30, wherein the polarizing beam splitter is in a telecentric space of the projection system.

32. A projection system comprising:
an imager capable of forming an image;
a projection lens system capable of projecting the image formed by the imager onto a viewing surface;
a polarizing element disposed between the imager and the projection lens system, the polarizing element being capable of directing light of a first polarization toward the imager and light of a second polarization different from the first polarization away from the imager; and
a color filter disposed between the polarizing element and the projection lens system, the color filter being polarization insensitive in the visible and capable of changing a color coordinate of light incident on the color filter.

33. The projection system of claim 32, wherein the color filter is capable of substantially reflecting light in a first wavelength range and substantially transmitting light in a second wavelength range different from the first wavelength range.

34. The projection system of claim 32, wherein the color filter is in a telecentric space of the projection system.
